(19) United States
(12) Patent Application Publication
(10) Pub. No.: US 2019/0112149 A1
(43) Pub. Date: Apr. 18, 2019

(54) ELEVATOR ASSIGNMENT TO MOBILE DEVICES AND FIXED DISPLAYS

(71) Applicants: Lucien WEDZIKOWSKI, Puteaux (FR); Otis Elevator Company, Farmington, CT (US)

(72) Inventors: Lucien Wedzikowski, Paris (FR); Bradley Armand Scoville, Farmington, CT (US); Ashley Chapman, Plainville, CT (US); Anne R. Davis, Middlefield, CT (US); Paul A. Simcik, Southington, CT (US)

(21) Appl. No.: 16/090,987

(22) PCT Filed: Apr. 6, 2016
(86) PCT No.: PCT/IB2016/000619

§ 371 Date: Oct. 3, 2018

(51) Int. Cl. B66B 1/46; B66B 3/00

(52) U.S. Cl. CPC B66B 1/468; B66B 2201/4653; B66B 2201/463; B66B 3/006

(57) ABSTRACT

A system and a method of notifying a user of an elevator assignment are provided. The method includes receiving, from an input device, an elevator call at an elevator controller from a user, calling, using the elevator controller, an elevator car based on the elevator call, generating, using the elevator controller, a call notification, receiving the call notification at a plurality of displays, and displaying the call notification on the plurality of displays based on a display parameter.

### TECHNICAL FIELD

The subject matter disclosed herein generally relates to displaying elevator assignments and, more particularly, to specific display usage settings for displaying elevator assignments.

### DESCRIPTION OF RELATED ART

A number of different indicators are provided to a user to indicate to the user that the user's elevator call has been received. For example, one such indictor is a button that lights up after a user pushes the button to call an elevator. Another example of a visual indicator is a display provided at a user input point that displays to the user the elevator call the user provided. Further, another indicator is a sound indicator, which is many times in the form of a ring, which an elevator car makes upon arrival to a floor.

However, additional indicators to help a user remain informed and aware of the elevator call and progress are desired.

### SUMMARY

According to one embodiment, a method of notifying a user of an elevator assignment is provided. The method includes receiving, from an input device, an elevator call at an elevator controller from a user, calling, using the elevator controller, an elevator car based on the elevator call, generating, using the elevator controller, a call notification, receiving the call notification at a plurality of displays, and displaying the call notification on the plurality of displays based on a display parameter.

In addition to one or more of the features described above, or as an alternative, further embodiments may include wherein the input device is one selected from a group consisting of a stationary device and a mobile device, and wherein the mobile device is one selected from a group consisting of a cellular phone, a wearable electronic, a laptop, a notebook, a netbook, and a tablet.

In addition to one or more of the features described above, or as an alternative, further embodiments may include wherein the call notification is one or more selected from a group consisting of text, an image, a video, a vibration, and an audio output.

In addition to one or more of the features described above, or as an alternative, further embodiments may include wherein the plurality of displays includes at least a display of a mobile device and a fixed display on a floor where the user is located.

In addition to one or more of the features described above, or as an alternative, further embodiments may include wherein the fixed display is one selected from a group consisting of a kiosk display, a display located adjacent to an elevator car bay door, a display on the same floor as the user, a display within visual range of the user, a display within wireless communication range of a user, a display in the elevator car, and a display within a defined range detectable using wireless communication and positioning.

In addition to one or more of the features described above, or as an alternative, further embodiments may include wherein the input device is a mobile device is linked to a plurality of mobile devices each with a display that is included in the plurality of displays.

In addition to one or more of the features described above, or as an alternative, further embodiments may include wherein the display parameter is one or more from a group consisting of a user floor, a display floor, a visual range mapping for a display, a signal strength threshold at a display, proximity information, floor location information, date, time, and scheduling information.

In addition to one or more of the features described above, or as an alternative, further embodiments may include transmitting the call notification from the elevator controller to the input device that is a mobile device in response to the elevator controller generating the call notification, and transmitting the call notification from the mobile device to selected displays from the plurality of displays.

In addition to one or more of the features described above, or as an alternative, further embodiments may include transmitting the call notification from the elevator controller to selected displays from the plurality of displays in response to the elevator controller generating the call notification.

According to an embodiment, a system for notifying elevator assignment is provided. The system includes an elevator including an elevator controller that is configured to receive an elevator call from an input device, call an elevator car, and generate a call notification, and the elevator car that is configured to travel between floors of a building based on the elevator call received from the elevator controller, a first display configured to receive the call notification and display the call notification based on a display parameter, and a second display configured to receive the call notification and display the call notification based on the display parameter.

In addition to one or more of the features described above, or as an alternative, further embodiments may include wherein the first display is one selected from a group consisting of a mobile device display, a kiosk display, a display located adjacent to an elevator car bay door, a display on the same floor as the user, a display within visual range of the user, a display within wireless communication range of a user, a display in the elevator car, and a display within a defined range detectable using wireless communication and positioning.

In addition to one or more of the features described above, or as an alternative, further embodiments may include wherein the second display is one selected from a group consisting of a mobile device display, a kiosk display, a display located adjacent to an elevator car bay door, a display on the same floor as the user, a display within visual range of the user, a display within wireless communication range of a user, a display within the elevator car, and a display within a defined range detectable using wireless communication and positioning.

In addition to one or more of the features described above, or as an alternative, further embodiments may include a plurality of displays configured to receive the call notification and display the call notification based on the display parameter, wherein one or more of the plurality of displays are selected from a group consisting of a mobile device display, a kiosk display, a display located adjacent to an elevator car bay door, a display on the same floor as the user, a display within visual range of the user, a display within wireless communication range of a user, a display within the elevator car, and a display within a defined range detectable using wireless communication and positioning.

In addition to one or more of the features described above, or as an alternative, further embodiments may include wherein the input device is a mobile device linked to a plurality of mobile devices each with a display that is included in the plurality of displays.

In addition to one or more of the features described above, or as an alternative, further embodiments may include wherein the input device is one selected from a group consisting of a cellular phone, a wearable electronic, a laptop, a notebook, a netbook, and a tablet.

In addition to one or more of the features described above, or as an alternative, further embodiments may include wherein the call notification is one or more selected from a group consisting of an image, a video, a vibration, and an audio output.

In addition to one or more of the features described above, or as an alternative, further embodiments may include wherein the display parameter is one or more from a group consisting of a user floor, a display floor, a visual range mapping for a display, a signal strength threshold at a display, proximity information, floor location information, date, time, scheduling.

According to an embodiment, a computer program product for notifying elevator assignment is provided. The computer program product including a computer readable storage medium having program instructions embodied therewith, the program instructions executable by a processor to cause the processor to receive, from an input device, an elevator call at an elevator controller from a user, call, using the elevator controller, an elevator car based on the elevator call, generate, using the elevator controller, a call notification, receive the call notification at a plurality of displays, and display the call notification on the plurality of displays based on a display parameter.

In addition to one or more of the features described above, or as an alternative, further embodiments may include additional program instructions executable by the processor to cause the processor to transmitting the call notification from the elevator controller to the input device that is a mobile device in response to the elevator controller generating the call notification, and transmitting the call notification from the mobile device to selected displays from the plurality of displays.

In addition to one or more of the features described above, or as an alternative, further embodiments may include additional program instructions executable by the processor to cause the processor to transmitting the call notification from the elevator controller to selected displays from the plurality of displays in response to the elevator controller generating the call notification.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 depicts an elevator system in accordance with one or more embodiments of the present disclosure;

FIG. 2 depicts a system for notifying one or more elevator assignments in accordance with one or more embodiments of the present disclosure;

FIG. 3 depicts a user and a system for notifying a user of elevator assignments in accordance with one or more embodiments of the present disclosure; and

FIG. 4 depicts a flow diagram of a method of notifying a user of elevator assignments in accordance with one or more embodiments of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise.

Embodiments described herein are directed to a method and system for displaying elevator notification on at least two or more displays for a user's benefit. For example, according to one or more embodiments, a system is provided that can send an assignment to a mobile device of the user that requested service and display the assignment on another display, which may be a fixed display, located in the building or another mobile display on the user. Accordingly, the system can provide an elevator assignment on a mobile device, such as a smart phone, digital smart watch, or other mobile device. Further, the system provides users with their assignment by also showing it on a fixed display in the building or elsewhere so they don't have to look at their mobile device as their only option.

According to one or more embodiments, publishing of the assignment to a fixed display is configurable. According to another embodiment, all displays on the same floor as the user display the assignment. Further, according to another embodiment, only displays near the user show the assignment. Further, according to another embodiment, the display could also show the assignment when the user approaches.

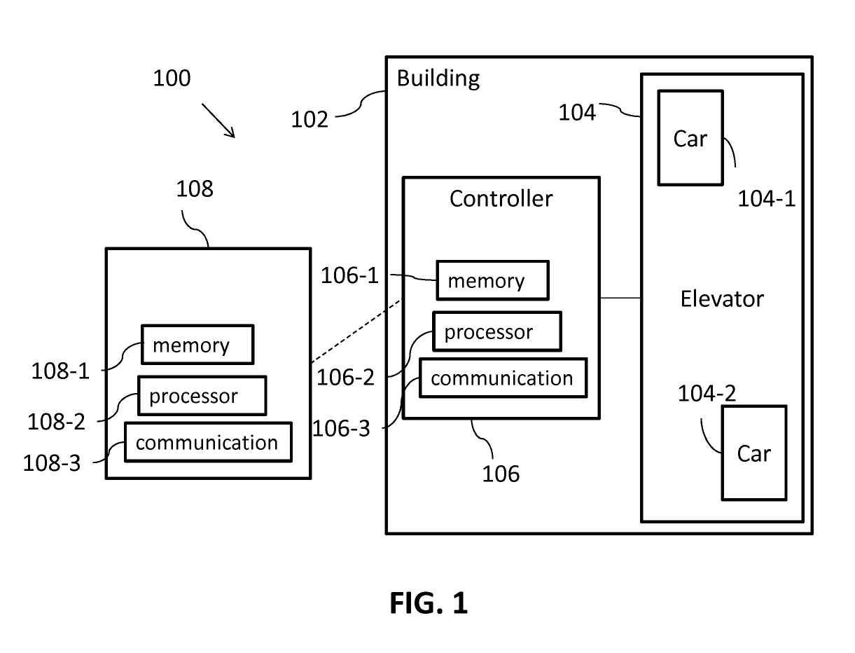

Turning now to the figures, FIG. 1 depicts an elevator system 100 in accordance with one or more embodiments. The elevator system 100 is shown installed at a building 102. In some embodiments, the building 102 may be an office building or a collection of office buildings that may or may not be physically located near each other. The building 102 may include a number of floors. Persons entering the building 102 may enter at a lobby floor, or another floor, and may go to a destination floor via one or more conveyance devices, such as an elevator 104.

The elevator 104 may be coupled to one or more computing devices, such as a controller 106. The controller 106 may be configured to control dispatching operations for one or more elevator cars (e.g., cars 104-1, 104-2) associated with the elevator 104. The elevator cars 104-1 and 104-2 may be located in the same hoistway or in different hoist ways so as to allow coordination amongst elevator cars in different elevator banks serving different floors. It is understood that other components of the elevator system 100 (e.g., drive, counterweight, safeties, etc.) are not depicted for ease of illustration.

Also shown in FIG. 1 is a mobile device 108. The mobile device 108 may include a device that is typically carried by a person, such as a phone, electronic wearable, RFID tag, tablet, PDA, etc. The mobile device 108 may include a processor 108-2, a memory 108-1, and a communication module 108-3 as shown in FIG. 1. The processor 108-2 can be any type or combination of computer processors, such as a microprocessor, microcontroller, digital signal processor, application specific integrated circuit, programmable logic device, and/or field programmable gate array. The memory 108-1 is an example of a non-transitory computer readable storage medium tangibly embodied in the mobile device 108 including executable instructions stored therein, for instance, as firmware. The communication module 108-3 may implement one or more communication protocols as described in further detail herein.

The controller 106 may include a processor 106-2, a memory 106-1, and communication module 106-3 as shown in FIG. 1. The processor 106-2 can be any type or combination of computer processors, such as a microprocessor, microcontroller, digital signal processor, application specific integrated circuit, programmable logic device, and/or field programmable gate array. The memory 106-1 is an example of a non-transitory computer readable storage medium tangibly embodied in the controller 106 including executable instructions stored therein, for instance, as firmware. The communication module 106-3 may implement one or more communication protocols as described in further detail herein.

The mobile device 108 and the controller 106 communicate with one another. According to one or more embodiments, the communication between the mobile device 108 and the controller 106 is done through other systems such as transmitters, converters, receivers, and other transmitting and processing elements depending on the communication type selected. For example, the mobile device 108 and the controller 106 may communicate with one another when proximate to one another (e.g., within a threshold distance). The mobile device 108 and the controller 106 may communicate over a wireless network, such as 802.11x (WiFi), short-range radio (Bluetooth), or any other known type of wireless communication. In some embodiments, the controller 106 may include, or be associated with (e.g., communicatively coupled to) a networked element, such as kiosk, beacon, hall call fixture, lantern, bridge, router, network node, etc. The networked element may communicate with the mobile device 108 using one or more communication protocols or standards. For example, the networked element may communicate with the mobile device 108 using near field communications (NFC), or any type of known wired or wireless communication means. According to one or more other embodiments, the networked element may communicate with the mobile device 108 through a cellular network or over the internet through a number of other devices outside the building.

In other embodiments, the controller 106 may establish communication with a mobile device 108 that is outside of the building 102. This connection may be established with various technologies including GPS, triangulation, or signal strength detection, by way of non-limiting example. The communication connection that can be established includes, but is not limited to, a cellular connection, a WiFi connection, a Bluetooth connection, a peer-to-peer connection, a satellite connection, a NFC connection, some other wireless connection, and even a wired connection using an Ethernet cable, coaxial cable, or other data cable. These communication connections may transport data between the mobile device 108 using a number of different networks ranging from a private secure direct communication link to transporting the data over the internet through multiple different servers, switches, etc. Such technologies that allow early communication will provide users and the systems more time to establish the most efficient passenger flow, and may eliminate the need for a user to stop moving to interact with the system.

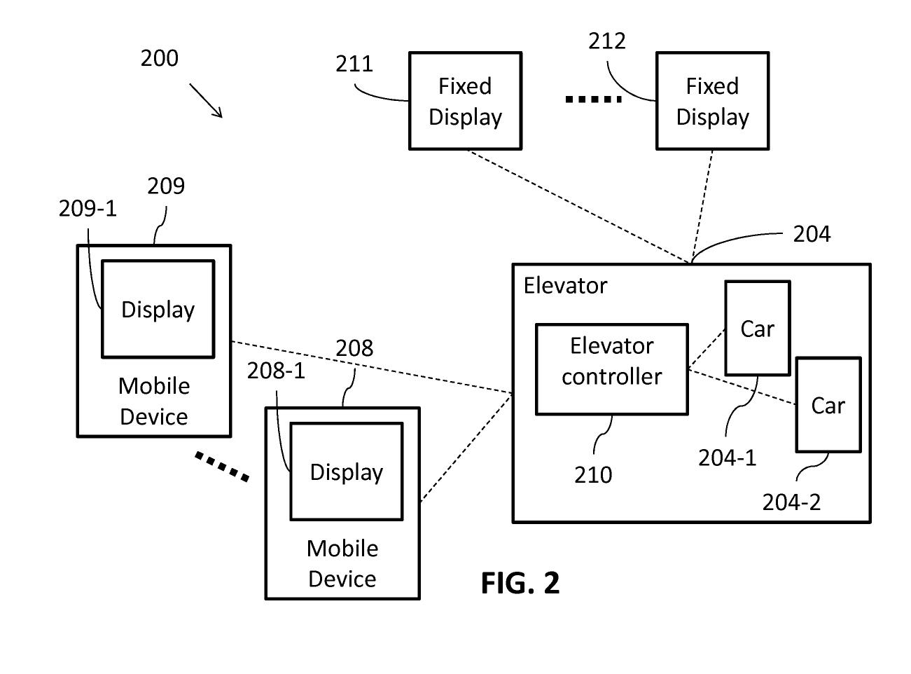

Implementation of a method and system of notifying elevator assignments to a user using the mobile device, controller, and elevator is described with reference to FIGS. 2-4.

Referring to FIG. 2, a system 200 for notifying one or more elevator assignments in accordance with one or more embodiments is shown. The system 200 includes at least one elevator 204, a first mobile device 208 that includes a display 208-1, and a first fixed display 211. According to one or more embodiments, the system 200 may include a plurality of mobile devices and/or fixed displays. For example, as shown, the system 200 includes at least a second mobile device 209 that includes a display 209-1 and a second fixed display 212. The elevator 204 includes one or more cars 204-1, 204-2 as well as a controller 210. The elevator controller 210 is shown within the elevator system 100, but may be located elsewhere as shown in FIG. 1.

According to one or more embodiments, the method of notifying elevator assignment includes receiving an elevator call from an input device. Specifically, according to one embodiment, the method of notifying elevator assignment includes receiving an elevator call from an input device that is a mobile device 208 at the elevator controller 210. According to another embodiment, the method of notifying elevator assignment includes receiving an elevator call from an input device that is a kiosk or some other non-mobile input device at the elevator controller 210. The elevator controller 210 will process the call by determining and calling one of the cars 204-1 or 204-2. The elevator controller 210 will also generate and transmit a call notification that is configured to be shown on a display. According to one embodiment, the call notification is received at the mobile device 208 that placed the elevator call as well as at a fixed display 211. The received call notification, discussed further below, is then displayed on both the mobile device 208 and the fixed display 211. According to another embodiment, the call notification may be received at the mobile device 208 and the mobile device 209 and then displayed on displays 208-1 and 209-1. Further, according to another embodiment, the call notification may be received at only the fixed display 211 and the fixed display 212 and displayed there. Further, according to one or more embodiments, any combination of at least two, but possibly more, displays receive and display the call notification. Accordingly, a user is provided with multiple locations at which to view the status of their elevator call.

According to one or more embodiments, the call notification may include an image, a video, an audio output, text, a vibration, or any combination thereof. According to one or more embodiments, the call notification may display elevator traffic information to a user. In another embodiment, the call notification will include and display emergency evacuation information for the user that made the call request. Further, according to one or more embodiments, the fixed display 211 may be a kiosk display, a display located adjacent to an elevator car bay door, a display on the same floor as the user, a display within visual range of the user, a display within wireless communication range of a user, a display in the elevator car, or a display within a defined range detectable using wireless communication and positioning.

According to another embodiment, the mobile device 208 and mobile device 209 may be linked together along with a plurality of mobile devices each with a display that is included in the plurality of displays. This group of mobile devices may receive a call notification that is generated based on a call made by any mobile device in the group.

For example, one or more embodiments can provide a group of users with the ability to travel together more efficiently, quickly, and/or easily. Particularly, according to one embodiment, the embodiment provides a grouping functionality provided by linking mobile devices together. This grouping can be used to better predict elevator usage and assignment by having a more accurate assessment of how many travelers need to travel together. Particularly, the grouped mobile devices can be provided a single call notification when one designated device from the group makes an elevator call. Further, the elevator system can adjust for multiple calls more accurately when the calls come from different devices in a single group. Also, notification to the group of mobile devices of the current status of elevator calls from group members can be provided. This can be done by providing notification to each mobile device that displays the notification on the mobile device display. Alternatively, in an embodiment were the building not only provides grouping capabilities but also tracking capabilities, the notifications can be displays on screens located throughout the building were ever member of the group currently reside informing them of the current status of an elevator call.

For example, a group of students traveling with a teacher may enter a building and need to use elevators to travel though the building. According to one embodiment, the teacher who may be designated as the group leader can make an elevator request that is transmitted to each of the students' mobile devices as well as one or more display screens in areas determined to be in visual proximity of any of the group members. This provides a quick and efficient way to call elevators sufficient to transport a group of people using only one elevator call and also provide notification to all group members of the elevator call.

According to another example, a family may be traveling through a building. In this embodiment a parent may generate and transmit an elevator call on behalf of the family group similar to the above example of students and a teacher. According to another embodiment, the elevator call can be displayed to all family members on their mobile devises and fixed displays in visual range. Further, the notification given to different group members can vary based on the role of that particular user. For example, children can be provided with bright and simple visual cues while parents can be provided with more complex notifications that provide additional information about the elevator call such as timing, current location of called car, etc.

Further, the fixed display nearest a child can display a distinct child friendly notification which can not only be useful to the child but can be used by a parent to determine more easily were their child is in relation to the fixed display that is showing the child friendly notification. For example, if a family walks into a building, and one child heads off to a restroom, when the parent who is waiting near the elevator banks makes the elevator call, the child specific notification may display on a fixed display near the restrooms away from the elevator banks. This can provide the parent with a visual clue as to the location of a family member and can also provide the elevator system with the ability to more accurately call an elevator for the group based on location information of group members.

Other embodiments can be provided that make use of the current system and method for displaying notifications. For example, in another embodiment, a group of engineers that each work on different floors of a building may need to attend a meeting on the same floor. The group leader can send a request out that calls elevators and notifies each of the team members through their mobile device and/or a nearby fixed display (such as a wall mounted screen or their desktop computer monitor) the status of the elevator call that was requested based on their group affiliation and location in the building. Accordingly, the dispersed group can be unified using a single request that then calls elevators to the group members and takes them to the designated meeting floor.

According to another embodiment, displaying the call notification may be done based on any number of items. For example, displaying the call notification can be done based on a user floor, a display floor, a visual range mapping for a display, a signal strength threshold at a display, proximity information, floor location information, date, time, and/or scheduling information. For example, as discussed above the call notification can be displayed based on the user floor location. This can include when there are multiple users in a group. Particularly, the call notification can be directed to the floor on which each group member is currently located on. Further, the call notification display can be done based on the location of the fixed display. For example, a call notification may be displayed on a fixed display near the elevator bay that a user has been assigned. Further, visual range mapping can be used to determine were a call notification is displayed. For example, the elevator system can include a mapping of each floor and fixed displays along with information about what areas in the mapped floor areas that is within visual range of each display. Then as a mobile device location is tracked, the fixed display can be switched to match the area the mobile device is in that provides a visual line of sight. According to another embodiment, each fixed display may have a sensor that can detect the signal strength of a signal being transmitted by the mobile device. The fixed display then displays the call notification when the detected signal strength reaches or exceeds a threshold value. Further, according to other embodiments, the displaying of the call notification can be determined based on the date, time, scheduling information, or other information that can be collected.

Further, according to another embodiment, the call notification that is transmitted from the elevator controller 210 may be sent to the user device 208 that initially requested the call. The user device 208 will then transmit the call notification to other displays and devices for the user. Alternatively, in another embodiment, the elevator controller 210 can transmit the call notification directly to a display that the controller 210 has selected for displaying the call notification.

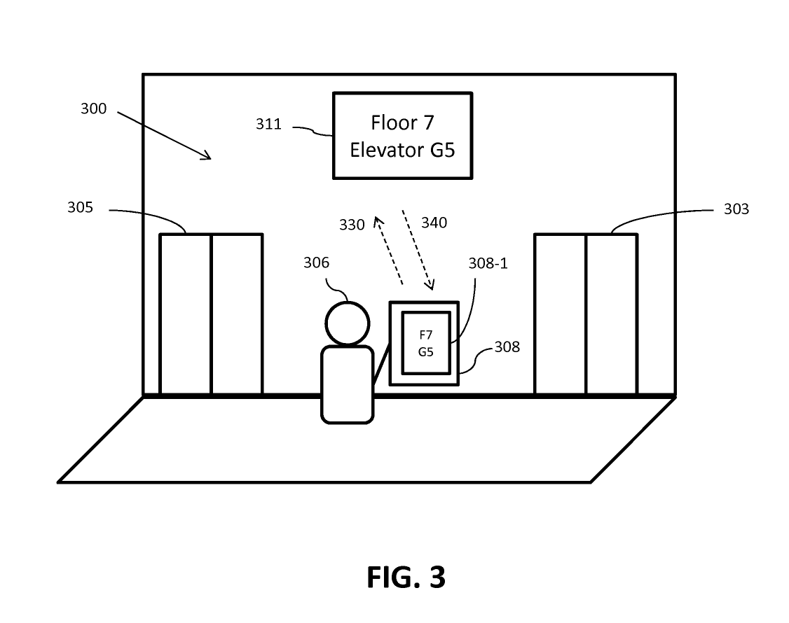

For example, as shown in FIG. 3, a user 306 is shown implementing a system for notifying elevator assignments according to one or more embodiments. As shown, the user 306 has a mobile device 308 that has a display 308-1. The mobile device 308 may any number of known mobile devices such as a cellular phone, a wearable electronic, a laptop, a notebook, a netbook, and a tablet, or any other known portable electronic device. The user 306 is shown within a building in an elevator lobby 300 within which the system is installed. For example, the elevator lobby 300 has a first elevator entrance 303 and a second elevator entrance 305. Further, a fixed display 311 is mounted on a wall within the elevator lobby 300. Accordingly, in one embodiment, the user 306 will transmit an elevator call 330 that is received by a sensor within wireless communication range of the mobile device 308 that transmitted the elevator call 330 to an elevator controller 210. According to another embodiment, the user 306 will transmit an elevator call 330 that is received by an independent communication system such as a cell tower that is part of a cellular network or through a wireless router than connects to the internet. The independent communication system then routes the elevator call 330 to the elevator controller 210. The elevator controller 210 may be located at the same location as the sensor, within an elevator, within the building 102, or may be located elsewhere as part of a cloud type processing system.

According to one or more embodiments, the elevator controller 210 will process an elevator call and select and call an elevator that will arrive at either elevator entrance 303 or 305. The elevator controller 210 will then transmit a generated call notification 340 to more than one display providing the user different options at which to view information relating to the user's request such as where the elevator will arrive or which opening to stand at. For example, as shown, the notification 340 is received by the mobile device 308 and displayed on the display 308-1 as well as the fixed display 311. Accordingly, a user 306 has options that provide information relating to the user's 306 elevator call 330. According to other embodiments, the call notification 340 may be displayed on another mobile device on the user 306, a mobile device of another user, or other fixed displays in the building.

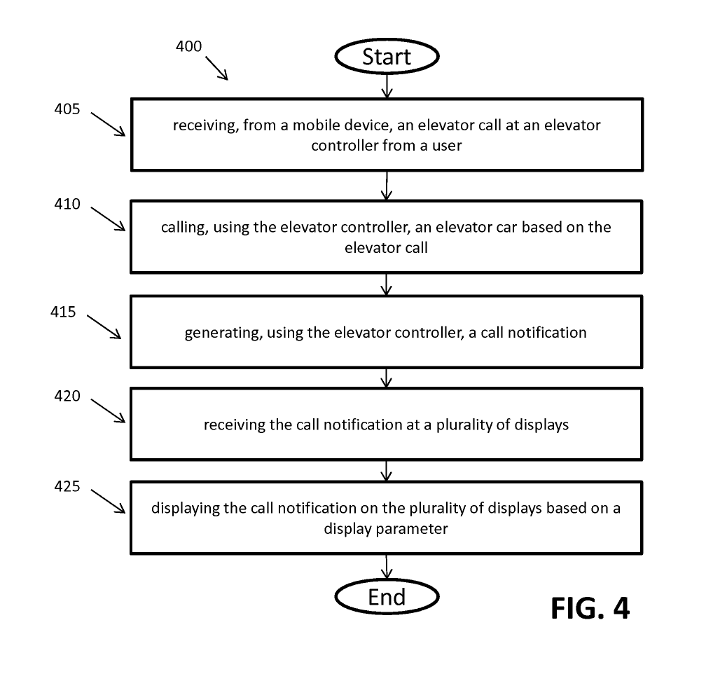

FIG. 4 depicts a flow diagram of a method 400 of notifying elevator assignments in accordance with one or more embodiments of the present disclosure. The method 400 includes receiving, from a mobile device, an elevator call at an elevator controller from a user (operation 405) and calling, using the elevator controller, an elevator car based on the elevator call (operation 410). The method 400 also includes generating, using the elevator controller, a call notification (operation 415). Further, the method 400 includes receiving the call notification at a plurality of displays (operation 420), and displaying the call notification on the plurality of displays based on a display parameter (operation 425).

According to another embodiment, the method may further include transmitting the call notification from the elevator controller to the mobile device in response to the elevator controller generating the call notification, and transmitting the call notification from the mobile device to selected displays from the plurality of displays. Alternatively, according to another embodiment, the method may include transmitting the call notification from the elevator controller to selected displays from the plurality of displays in response to the elevator controller generating the call notification. For example, according to one or more embodiments, the plurality of displays may include one or more of a kiosk display, a display located adjacent to an elevator car bay door, a display on the same floor as the user, a display within visual range of the user, a display within wireless communication range of a user, a display in the elevator car, and a display within a defined range detectable using wireless communication and positioning. Further, according to another embodiment, multiple of any one type of display can be included in the plurality of displays.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable program instructions may execute entirely on the user's mobile device, partly on the user's mobile device, as a stand-alone software package, partly on the user's mobile device and partly on a remote computer or entirely on the remote computer or server. In the latter scenario, the remote computer may be connected to the user's mobile device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

What is claimed is:

1. A method of notifying a user of an elevator assignment, the method comprising:
receiving, from an input device, an elevator call at an elevator controller from a user;
calling, using the elevator controller, an elevator car based on the elevator call;
generating, using the elevator controller, a call notification;
receiving the call notification at a plurality of displays; and
displaying the call notification on the plurality of displays based on a display parameter.

2. The method of claim 1, wherein the input device is one selected from a group consisting of a stationary device and a mobile device, and wherein the mobile device is one selected from a group consisting of a cellular phone, a wearable electronic, a laptop, a notebook, a netbook, and a tablet.

3. The method of claim 1, wherein the call notification is one or more selected from a group consisting of text, an image, a video, a vibration, and an audio output.

4. The method of claim 1, wherein the plurality of displays includes at least a display of a mobile device and a fixed display on a floor where the user is located.

5. The method of claim 4, wherein the fixed display is one selected from a group consisting of a kiosk display, a display located adjacent to an elevator car bay door, a display on the same floor as the user, a display within visual range of the user, a display within wireless communication range of a user, a display in the elevator car, and a display within a defined range detectable using wireless communication and positioning.

6. The method of claim 1, wherein the input device is a mobile device is linked to a plurality of mobile devices each with a display that is included in the plurality of displays.

7. The method of claim 1, wherein the display parameter is one or more from a group consisting of a user floor, a display floor, a visual range mapping for a display, a signal strength threshold at a display, proximity information, floor location information, date, time, and scheduling information.

8. The method of claim 1, further comprising:
transmitting the call notification from the elevator controller to the input device that is a mobile device in response to the elevator controller generating the call notification; and
transmitting the call notification from the mobile device to selected displays from the plurality of displays.

9. The method of claim 1, further comprising:
transmitting the call notification from the elevator controller to selected displays from the plurality of displays in response to the elevator controller generating the call notification.

10. A system for notifying elevator assignment, the system comprising:
an elevator comprising:
an elevator controller that is configured to receive an elevator call from an input device, call an elevator car, and generate a call notification; and
the elevator car that is configured to travel between floors of a building based on the elevator call received from the elevator controller;
a first display configured to receive the call notification and display the call notification based on a display parameter; and
a second display configured to receive the call notification and display the call notification based on the display parameter.

11. The system of claim 10, wherein the first display is one selected from a group consisting of a mobile device display, a kiosk display, a display located adjacent to an elevator car bay door, a display on the same floor as the user, a display within visual range of the user, a display within wireless communication range of a user, a display in the elevator car, and a display within a defined range detectable using wireless communication and positioning.

12. The system of claim 10, wherein the second display is one selected from a group consisting of a mobile device display, a kiosk display, a display located adjacent to an elevator car bay door, a display on the same floor as the user, a display within visual range of the user, a display within wireless communication range of a user, a display within the elevator car, and a display within a defined range detectable using wireless communication and positioning.

13. The system of claim 10, further comprising:
a plurality of displays configured to receive the call notification and display the call notification based on the display parameter,
wherein one or more of the plurality of displays are selected from a group consisting of a mobile device display, a kiosk display, a display located adjacent to an elevator car bay door, a display on the same floor as the user, a display within visual range of the user, a display within wireless communication range of a user, a display within the elevator car, and a display within a defined range detectable using wireless communication and positioning.

14. The system of claim 13, wherein the input device is a mobile device linked to a plurality of mobile devices each with a display that is included in the plurality of displays.

15. The system of claim 10, wherein the input device is one selected from a group consisting of a cellular phone, a wearable electronic, a laptop, a notebook, a netbook, and a tablet.

16. The system of claim 10, wherein the call notification is one or more selected from a group consisting of an image, a video, a vibration, and an audio output.

17. The system of claim 10, wherein the display parameter is one or more from a group consisting of a user floor, a display floor, a visual range mapping for a display, a signal strength threshold at a display, proximity information, floor location information, date, time, scheduling.

18. A computer program product for notifying elevator assignment, the computer program product comprising a computer readable storage medium having program instructions embodied therewith, the program instructions executable by a processor to cause the processor to:
receive, from an input device, an elevator call at an elevator controller from a user;
call, using the elevator controller, an elevator car based on the elevator call;
generate, using the elevator controller, a call notification;
receive the call notification at a plurality of displays; and
display the call notification on the plurality of displays based on a display parameter.

19. The computer program product of claim 18, the computer program product comprising additional program instructions executable by the processor to cause the processor to:
transmitting the call notification from the elevator controller to the input device that is a mobile device in response to the elevator controller generating the call notification; and
transmitting the call notification from the mobile device to selected displays from the plurality of displays.

20. The computer program product of claim 18, the computer program product comprising additional program instructions executable by the processor to cause the processor to:
transmitting the call notification from the elevator controller to selected displays from the plurality of displays in response to the elevator controller generating the call notification.
